(19) United States
(12) Patent Application Publication
(10) Pub. No.: US 2004/0262522 A1
(43) Pub. Date: Dec. 30, 2004

(54) Infrared confocal scanning type microscope and measuring method

(75) Inventors: Akihiro Kitahara, Hachioji-shi (JP); Shigeru Kanegae, Ina-shi (JP); Yasuo Nishiyama, Hino-shi (JP); Yukinaga Shitamichi, Hino-shi (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/859,850

(22) Filed: Jun. 3, 2004

(30) Foreign Application Priority Data
Jun. 3, 2003 (JP) 2003-158504
Jun. 11, 2003 (JP) 2003-166751

(51) Int. Cl. G01J 5/02

(52) U.S. Cl. 250/341.8

(57) ABSTRACT

An infrared confocal scanning microscope includes a light source unit, which emits a beam of infrared light, an objective lens, which converges the beam of infrared light from the light source unit to form a light spot inside the sample, a scanning mechanism, which two-dimensionally scans the light spot in a plane perpendicular to an optical axis, and a photodetector. The photodetector includes a micro light receiving region, which is in a confocal positional relation with respect to the light spot, and constitutes a substantial micro opening.

### CROSS-REFERENCE TO RELATED APPLICATIONS

This application is based upon and claims the benefit of priority from prior Japanese Patent Applications No. 2003-158504, filed Jun. 3, 2003; and No. 2003-166751, filed Jun. 11, 2003, the entire contents of both of which are incorporated herein by reference.

### BACKGROUND OF THE INVENTION

1. Field of the Invention

The present invention relates to a microscope that observes inside of a sample using infrared light.

2. Description of the Related Art

A technique has been known in which an IC chip or a micro electro mechanical system (MEMS) structure after flip chip bonding (FCB) is observed using infrared light capable of passing through silicon.

Jpn. Pat. Appln. KOKAI Publication No. 5-152401 discloses a method that observes a bump bonded shape bonded to a printed substrate from the back surface of a silicon chip including a bump bonded to the chip. This document describes an apparatus comprising an objective and an infrared camera, and another apparatus further comprising a light source, a scanner, a light receiving element, and an aperture constituting an optical confocal system.

Jpn. Pat. Appln. KOKAI Publication No. 11-183406 discloses a device that inspects a bonded shape using a usual infrared microscope. A laser focus displacement meter disposed in the device is used. First, a position is measured with the laser focus displacement meter on the back surface of a silicon chip IC, next a circuit substrate position close to a bonded portion is measured, and a height with respect to the bonded portion is measured with a positional difference to judge defects.

### BRIEF SUMMARY OF THE INVENTION

The present invention is, in an aspect, directed to an infrared confocal scanning microscope for observing the inside of a sample.

An infrared confocal scanning microscope of the present invention comprises a light source unit, which emits a beam of infrared light, an objective lens, which converges the beam of infrared light from the light source unit to form a light spot inside a sample, a scanning mechanism, which two-dimensionally scans the light spot in a plane perpendicular to an optical axis, and a photodetector. The photodetector has a micro light receiving region, which is in a confocal positional relation with respect to the light spot, and constitutes a substantial micro opening.

Another infrared confocal scanning microscope of the present invention comprises a light source unit, which emits a beam of infrared light, an objective lens, which converges the beam of infrared light from the light source unit to form a light spot inside a sample, a scanning mechanism, which two-dimensionally scans the light spot in a plane perpendicular to an optical axis, a substantial micro opening, which is in a confocal positional relation with respect to the light spot, and a photodetector to detect reflected (infrared) light that has passed through the substantial micro opening from the sample.

A further infrared confocal scanning microscope of the present invention comprises a light source unit, which emits a beam of infrared light, an objective is lens, which converges the beam of infrared light from the light source unit to form a light spot inside a sample, a scanning mechanism, which two-dimensionally scans the light spot in a plane perpendicular to an optical axis, a disc, which is in a confocal positional relation with respect to the light spot and on which light transmitting portions and light interrupting portions are formed with predetermined patterns crossing an optical path of the infrared light, and an image pickup device capable of detecting the light in a region that has a two-dimensional spread.

The present invention is, in another aspect, directed to a measuring method that measures relative positions of a plurality of portions in a sample. A measuring method of the present invention comprises converging a beam of infrared light to form a light spot inside a sample, two-dimensionally scanning the light spot in a plane, detecting reflected (infrared) light from the sample in a confocal position with respect to the light spot, forming an image of the plane in which the light spot is positioned based on positions of the detected reflected (infrared) light and the light spot, repeating these operations with changing a height position of the light spot to acquire a plurality of images, synthesizing the plurality of acquired images to form an extended image focused in all height positions, and measuring relative positions of a plurality of portions in the sample based on the formed extended image.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows a constitution of an infrared confocal scanning microscope of light beam scanning type according to a first embodiment of the present invention;

FIG. 2 shows transmittance characteristics of silicon with respect to a wavelength of light;

FIG. 3 is a graph showing a relation between relative positions (Z) of an objective lens and a sample and an output of a photodetector, that is, light intensity (I) in the infrared confocal scanning is microscope shown in FIG. 1;

FIG. 4 shows an FCB mounted package, which is an example of the sample observed by the infrared confocal scanning microscope shown in FIG. 1, and shows a state in which infrared light is focused on the lower surface of a silicon chip;

FIG. 5 shows an FCB mounted package, which is an example of the sample observed by the infrared confocal scanning microscope shown in FIG. 1, and shows a state in which the infrared light is focused on the upper surface of a printed substrate;

FIG. 6 shows another objective lens applicable instead of the objective lens shown in FIG. 1;

FIG. 6A shows an objective lens and objective caps, one of which is selectively mounted on the end of the objective lens;

FIG. 7 shows a constitution of the infrared confocal scanning microscope of light beam scanning type according to a second embodiment of the present invention;

FIG. 8 shows a constitution of a light source unit shown in FIG. 7;

FIG. 9 shows another constitution of the light source unit shown in FIG. 7;

FIG. 10 shows a modeled sample measured with the infrared confocal scanning microscope shown in FIG. 7;

FIG. 11 shows a constitution of the infrared confocal scanning microscope of disc scanning type according to a third embodiment of the present invention;

FIG. 12 shows a constitution of a modification of the infrared confocal scanning microscope of disc scanning type according to the third embodiment;

FIG. 13 shows a constitution of an infrared wavelength filter turret shown in FIG. 12;

FIG. 14 shows another constitution of the infrared wavelength filter turret shown in FIG. 12;

FIG. 15 shows a constitution of another modification of the infrared confocal scanning microscope of disc scanning type according to the third embodiment;

FIG. 16 is a plan view of a rotary disc shown in FIG. 15;

FIG. 17 shows a constitution of a height measurement apparatus according to a fourth embodiment of the present invention;

FIG. 18 is an optical path diagram of gap measurement of the FCB mounted package; and

FIG. 19 shows a constitution of a modification of the height measurement apparatus according to the fourth embodiment.

### DETAILED DESCRIPTION OF THE INVENTION

Embodiments of the present invention will be described hereinafter with reference to the drawings.

First Embodiment

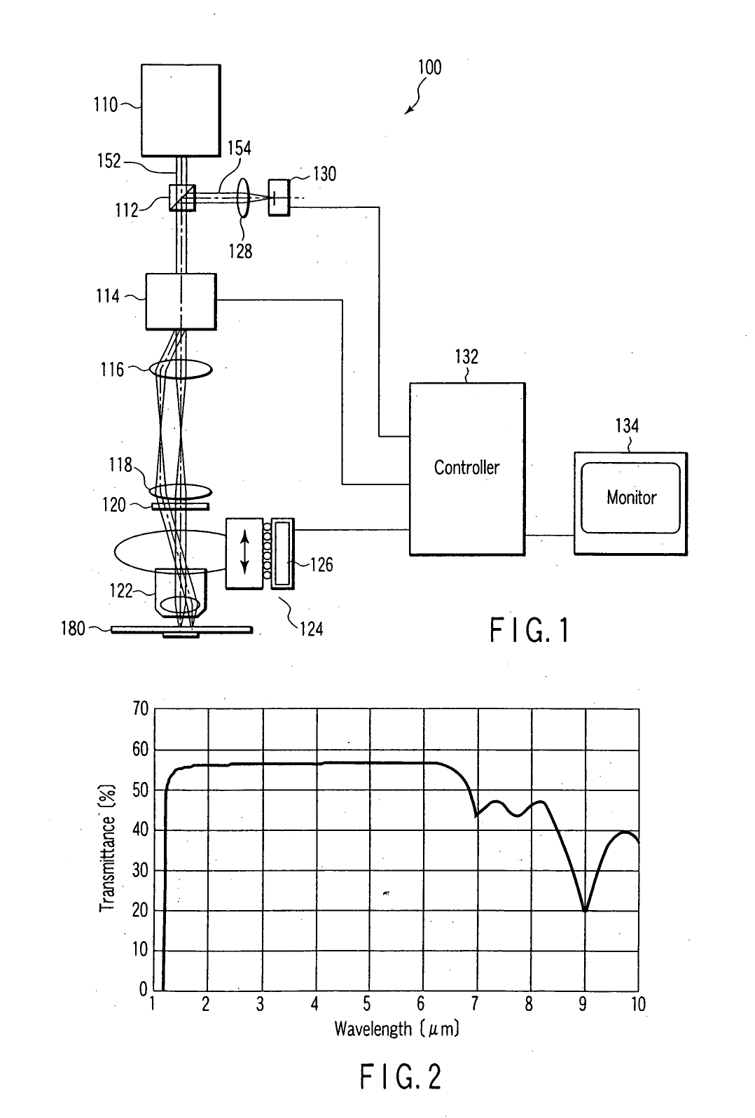

The present embodiment is directed to an infrared confocal scanning microscope of light beam scanning type. FIG. 1 shows a constitution of the infrared confocal scanning microscope of a first embodiment of the present invention.

As shown in FIG. 1, an infrared confocal scanning microscope 100 of the present embodiment has a light source unit 110, which emits a beam of infrared light, a two-dimensional scanning mechanism 114, which two-dimensionally scans the beam of infrared light from the light source unit 110, an objective lens 122, which converges the scanned beam of infrared light to form a light spot inside a sample 180, an objective lens movement mechanism 124, which moves the objective lens 122 along an optical axis, and a Z scale 126, which detects movement of the objective lens 122 along the optical axis.

The infrared confocal scanning microscope 100 has a polarizing beam splitter (PBS) 112 on an optical path between the light source unit 110 and two-dimensional scanning mechanism 114, and a pupil projection lens 116, image forming lens 118, and quarter-wave plate 120 on an optical path between the two-dimensional scanning mechanism 114 and objective lens 122. The PBS 112 cooperates with the quarter-wave plate 120 to selectively separate a beam of reflected infrared light from the sample 180 and the beam of infrared light directed to the sample 180 on the basis of the polarization.

The infrared confocal scanning microscope 100 further includes a converging lens 128, which converges the beam of reflected infrared light separated by the PBS 112, a photodetector 130, which detects the reflected infrared light converged by the converging lens 128, a controller 132, which controls the two-dimensional scanning mechanism 114, and processes information obtained by the Z scale 126 and photodetector 130, and a monitor 134, which displays a processing result (image) obtained by the controller 132.

In the present embodiment, the sample 180 is, but is not limited to, for example, an IC chip or a micro electro mechanical system (MEMS) structure after flip chip bonding (FCB), inside which an observation portion is positioned. An observation object is, for example, a pattern state of the IC chip, a gap of a space in the MEMS structure, or the like.

The IC chip or the MEMS structure is prepared using silicon as a main material. FIG. 2 shows transmittance characteristics of silicon with respect to a wavelength of light. As seen from FIG. 2, silicon hardly transmits light in a wavelength band of about 1.1 μm or less, but comparatively well transmits light in a wavelength band of 1.1 μm or more.

The light source unit 110 emits light having a wavelength capable of passing through silicon, that is, light having a wavelength of 1.1 μm or more. Since an obtained image has a higher resolution with a shorter wavelength of light for use, the light source unit 110 may more preferably emit light having a wavelength close to 1.1 μm and a transmittance of about 50%. For example, an LD that emits light having a wavelength of 1.3 μm is inexpensive, has satisfactory availability, and is preferably usable.

The two-dimensional scanning mechanism 114 is constituted, for example, by a combination of two galvano mirrors. The two-dimensional scanning mechanism 114 is disposed in a position conjugated with a pupil of the objective lens 122. The objective lens 122 whose aberration by thickness of silicon in the sample 180 is corrected may be used.

In FIG. 1, a beam 152 of infrared light from the light source unit 110 passes through the PBS 112, and is two-dimensionally scanned by the two-dimensional scanning mechanism 114. The beam 152 of infrared light that has passed through the two-dimensional scanning mechanism 114 passes through the pupil projection lens 116, image forming lens 118, and quarter-wave plate 120, and is converged inside the sample 180 by the objective lens 122 to form a light spot. The light spot formed inside the sample 180 is scanned in a plane perpendicular to an optical axis in accordance with the two-dimensional scanning of the beam by the two-dimensional scanning mechanism 114.

FIGS. 4 and 5 show an FCB mounted package, which is an example of the sample 180. The package 180 has a silicon chip 182 and a printed substrate 188 bonded to each other by a bump 192. For example, the silicon chip 182 includes a wiring pattern 184 and an aluminum pad 186, the printed substrate 188 includes a land 190, and the aluminum pad 186 is electrically connected to the land 190 by the bump 192.

For example, as shown in FIG. 4, the beam 152 of infrared light passes through the silicon chip 182, and is reflected by the wiring pattern 184 on the back surface of the chip. Alternatively, as shown in FIG. 5, the beam passes through the silicon chip 182, and is reflected by the front surface of the printed substrate 188.

In FIG. 1, the beam of reflected infrared light from the sample 180 returns along an incident optical path to the sample 180 in reverse, and reaches the PBS 112 via the objective lens 122, quarter-wave plate 120, image forming lens 118, pupil projection lens 116, and two-dimensional scanning mechanism 114.

The infrared light emitted from the light source unit 110 is linearly polarized, and the infrared light is converted to circularly polarized light through the quarter-wave plate 120 while returning to the sample 180. The infrared light reflected by the 180 passes again through the quarter-wave plate 120 before reaching the PBS 112, and is accordingly converted to the linearly polarized light from the circularly polarized light. This linearly polarized light is perpendicular to the linearly polarized light that has been just emitted from the light source unit 110.

Therefore, the beam of the reflected infrared light from the sample 180 is reflected by the PBS 112, and selectively separated from the beam 152 of infrared light directed to the sample 180 to form a beam 154 of detected light. The beam 154 of detected light is converged by the converging lens 128, and falls on the photodetector 130.

The photodetector 130 has a light receiving surface having such a size that the surface functions substantially as a micro opening, and the light receiving surface is disposed in a position confocal with respect to the light spot formed inside the sample 180. Therefore, an optical system shown in FIG. 1 constitutes an optical confocal system.

Here, assuming that a beam diameter of the beam 154 of detected light is W, a focal distance of the converging lens 128 is f, and a wavelength of light emitted from the light source unit 110 is λ, a spot diameter d focused by the converging lens 128 is represented by d=4fλ/πW. On the other hand, a diameter D of the light receiving surface of the photodetector 130 satisfies d/4≦D≦d/3. In other words, the converging lens 128 and photodetector 130 are designed in this manner.

The photodetector 130 outputs an electric signal in accordance with incident light intensity. The electric signal from the photodetector 130 is taken into by the controller 132. The controller 132 forms an image based on the electric signal from the photodetector 130 and positional information of the light spot. The positional information of the light spot is obtained from a control signal of the two-dimensional scanning mechanism 114. The formed image is displayed in the monitor 134.

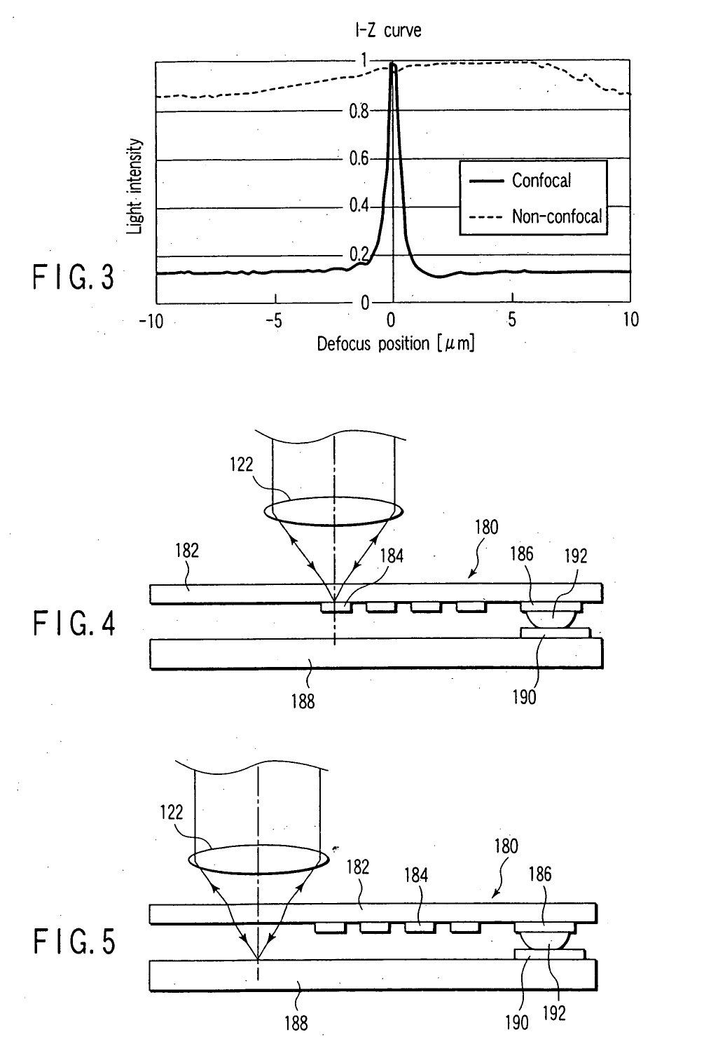

FIG. 3 is a graph showing a relation between relative positions (Z) of the objective lens and sample and the output of the photodetector, that is, light intensity (I), in the infrared confocal scanning microscope 100. That is, it is a graph of Z-coordinate to light intensity, generally referred to as an I-Z curve. In FIG. 3, for comparison, a graph of Z-coordinate to light intensity in a usual non-confocal microscope is also shown.

As seen from FIG. 3, in the non-confocal microscope, an intensity of reflected light from a Z position deviating from a focus is also high, and is sometimes higher than that of the reflected light from a focal position as the case may be. Therefore, even when there is much undesired noise light, and the beam of infrared light is focused on the observation object, a clear image is not easily obtained.

On the other hand, in the confocal microscope, the intensity of reflected light from the focal position is high, but the intensity of reflected light from the Z-position deviating from the focus is excessively small. Therefore, a clear image of a plane in which there is little noise light and a focal plane, that is, the light spot is positioned is obtained.

In the infrared confocal scanning microscope 100, with the use of characteristics of the optical confocal system, a position of the objective lens 122 with respect to the sample 180 is adjusted along an optical axis of the objective lens 122 by the objective lens movement mechanism 124 to maximize the light intensity detected by the photodetector 130. Accordingly, it is possible to adjust the position along the optical axis of the light spot, that is, the focal position to the targeted observation point.

That is, for example, as shown in FIG. 4, when the optical axis crosses the wiring pattern 184, the position of the objective lens 122 is adjusted along the optical axis to maximize the light intensity detected by the photodetector 130, and accordingly the light spot is disposed on the lower surface of the silicon chip 182. A clear image of the wiring pattern 184 with a high contrast can be obtained by scanning the light spot on this plane.

Moreover, as shown in FIG. 5, when any device of the silicon chip 182 does not exist on the optical axis, the position along the optical axis of the objective lens 122 is adjusted to maximize the light intensity detected by the photodetector 130, and accordingly the light spot is disposed on the upper surface of the printed substrate 188. A clear image of the printed substrate 188 with a high contrast can be obtained by scanning the light spot on this plane.

Furthermore, since a clear image having a high contrast on the same plane perpendicular to the optical axis can be obtained, the controller 132 is also capable of measuring dimensions among a plurality of portions on the same plane in the sample, such as a pitch of the wiring pattern 184, based on the image.

Additionally, the controller 132 is also capable of measuring the dimensions along the optical axis among the plurality of portions in the sample, such as an interval between the silicon chip 182 and printed substrate 188 by measuring the movement of the objective lens 122 along the optical axis based on the information obtained by the Z scale 126.

Furthermore, the controller 132 may also obtain an image (extended image) focused in all the different heights by acquiring the images for different heights of the observation object to synthesize (superimposes) them. Accordingly, it is also possible to measure dimensions on a plane perpendicular to the optical axis, among the plurality of portions in different positions along the optical axis.

It is possible to three-dimensionally measure the portion in the sample in this manner. Accordingly, it is possible to measure lengths, areas, or shapes of the wiring pattern, bump, aluminum pad and the like.

That is, in the infrared confocal scanning microscope 100 of the present embodiment, it is possible to measure the positions of the land (wiring) and aluminum pad. Accordingly, it is possible to know pressurizing condition setting or a bonded state of the bump. Moreover, it is possible to measure sizes of foreign matters of an aluminum pad portion by bump shortage. It is possible to observe a damage of the pattern on a substrate circuit, ground shift of the substrate circuit, pad change at a bump preparation time and the like. It is also possible to measure sizes of air layers, referred to as under voids, generated in materials injected into the silicon chip and printed substrate.

In the usual infrared microscope, a usable magnification of the objective lens is about 20 times, but in the infrared confocal scanning microscope 100 of the present embodiment, the objective lens with a magnification of about 100 times at maximum is usable, and high resolution observation is possible.

Modification

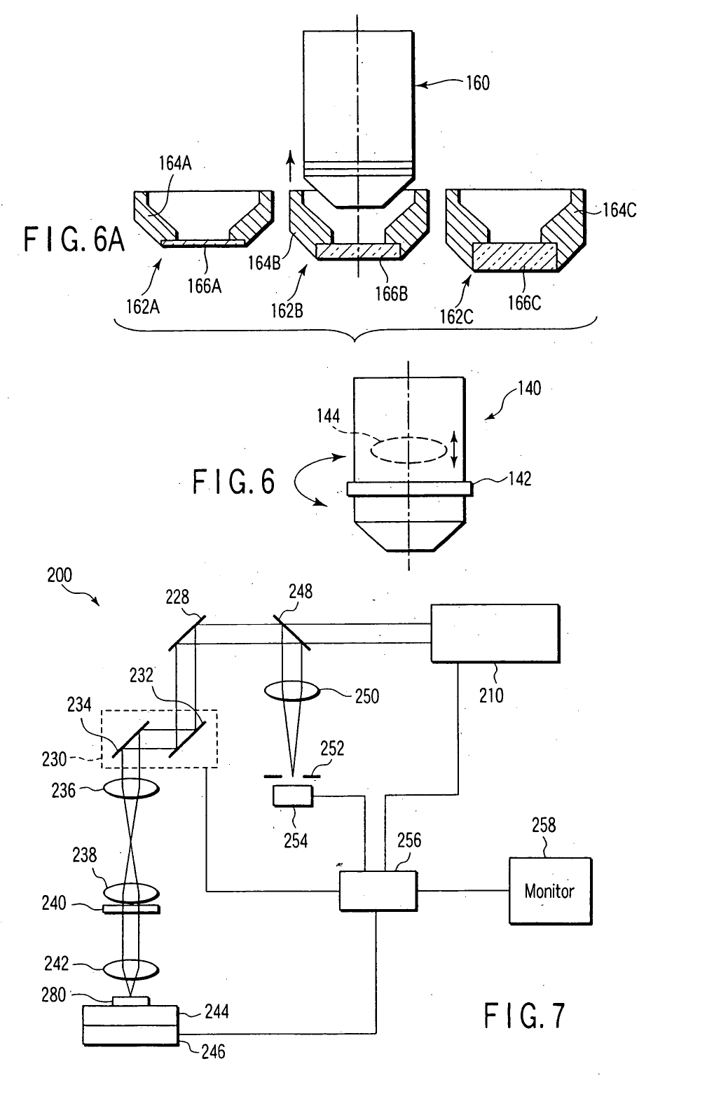

FIG. 6 shows another objective lens that may be used in place of the objective lens 122 shown in FIG. 1. As shown in FIG. 6, an objective lens 140 has a rotatable correction ring 142, and optical elements 144 such as a lens to be moved along the optical axis in response to rotation of the correction ring 142. The correction ring 142 is connected to the optical element 144 through a mechanical mechanism (not shown), which moves the optical element 144 along the optical axis with the rotation of the correction ring 142. The aberration resulting from the material (e.g., material contained in the silicon wafer) and the thickness of the sample 180 can be corrected by rotating the correction ring 142 through an appropriate angle. Accordingly, it is possible to obtain a more preferable image that has no aberration.

In the modification, the aberration is corrected, but not limited to, by the correction ring 142. Instead, an objective cap for correcting the aberration may be mounted on the end of an ordinary-type objective lens. FIG. 6A shows an objective lens and objective caps, one of which is selectively mounted on the end of the objective lens. As shown in FIG. 6A, various objective caps 162A, 162B, and 162C may be prepared because the aberration depends on the material and thickness of a sample, and one of the objective caps 162A, 162B, and 162C is selectively mounted on the end of the objective lens 160, if needed. The objective caps 162A, 162B, and 162C respectively comprise hollow caps 164A, 164B, and 164C, which can be mounted on the end of the objective lens 160, and optical elements 166A, 166B, and 166C, which have different thickness for samples. The optical elements 166A, 166B, and 166C are of, for example, glass or silicon, and may be of the same material as the sample to be examined.

Second Embodiment

The present embodiment is directed to another infrared confocal scanning microscope of light beam scanning type. FIG. 7 shows a constitution of the infrared confocal scanning microscope according to the second embodiment of the present invention.

As shown in FIG. 7, an infrared confocal scanning microscope 200 of the present embodiment has a light source unit 210, which emits a beam of infrared light, a mirror 228, which deflects the beam of infrared light from the light source unit 210, a two-dimensional scanning mechanism 230, which two-dimensionally scans the beam of infrared light from the mirror 228, an objective lens 242, which converges the scanned beam of infrared light to form a light spot inside a sample 280, a sample base 244, on which the sample 280 is to be laid, and a Z-stage 246 capable of moving the sample 280 together with the sample base 244 along the optical axis. The two-dimensional scanning mechanism 230 comprises, but not limited to, for example, two galvano mirrors 232 and 234.

The infrared confocal scanning microscope 200 includes a polarizing beam splitter (PBS) 248 on an optical path between the light source unit 210 and the mirror 228, and a pupil projection lens 236, an image forming lens 238, and quarter-wave plate 240 on an optical path between the two-dimensional scanning mechanism 230 and the objective lens 242. The PBS 248 cooperates with the quarter-wave plate 240 to selectively separate a beam of reflected infrared light from the sample 280 and the beam of infrared light directed toward the sample 280 based on polarized light on the basis of the polarization.

The infrared confocal scanning microscope 200 further includes a converging lens 250, which converges the beam of reflected infrared light separated by the PBS 248, a pinhole 252, which is disposed on the optical path of reflected infrared light from the converging lens 250, a photodetector 254, which detects the reflected infrared light that has passed through the pinhole 252, a controller 256 such as a computer, which controls the two-dimensional scanning mechanism 230 and processes information obtained by the photodetector 254, and a monitor 258, which displays a processing result (image) obtained by the controller 256. The pinhole 252 is disposed in a position confocal with respect to the light spot formed by the objective lens 242. The controller 256 is capable of measuring the movement of the Z-stage 246.

The beam of infrared light emitted from the light source unit 210 passes through the PBS 248, and is deflected by the mirror 228 and scanned by the two-dimensional scanning mechanism 230. The beam of infrared light that has passed through the two-dimensional scanning mechanism 230 passes through the pupil projection lens 236, image forming lens 238, quarter-wave plate 240, and is subsequently converged inside the sample 280 by the objective lens 242 to form a light spot. The light spot formed inside the sample 280 is scanned in a plane perpendicular to the optical axis in accordance with two-dimensional scanning of the beam by the two-dimensional scanning mechanism 230.

The beam of reflected infrared light from the sample 280 reaches the PBS 248 through the objective lens 242, the quarter-wave plate 240, image forming lens 238, pupil projection lens 236, two-dimensional scanning mechanism 230, and mirror 228. The reflected infrared light that has reached the PBS 248 is a linearly polarized light perpendicular to the linearly polarized infrared light from the light source unit 210, and is reflected by the PBS 248. The beam of the reflected infrared light reflected by the PBS 248 is converged by the converging lens 250, and falls on the photodetector 254 via the pinhole 252.

The photodetector 254 outputs an electric signal in accordance with an intensity of incident light. The electric signal from the photodetector 254 is taken into the controller 256. The controller 256 forms an image based on the electric signal from the photodetector 254 and the positional information of the light spot. The positional information of the light spot is obtained from the control signal of the two-dimensional scanning mechanism 230. The formed image is displayed in the monitor 258.

The infrared confocal scanning microscope 200 constitutes an optical confocal system, and only the reflected infrared light from the light spot formed by the objective lens 242 is capable of satisfactorily passing through the pinhole 252 as described in detail in the first embodiment. The reflected infrared light from a position deviating from the light spot along the optical axis is capable of hardly passing through the pinhole 252. Therefore, an image on a plane perpendicular to the optical axis on which the light spot is positioned is obtained with a high contrast.

A most preferable wavelength of infrared light applied onto the sample 280 depends on a material constituting the sample 280. This is because with a shorter wavelength of light applied onto the sample 280, resolution of the obtained image becomes higher and, the other hand, transmittance of the sample 280 is very low.

The light source unit 210 can emit beams of infrared light having wavelengths in order to apply the infrared light having a more preferable wavelength to the sample 280 in accordance with actual situations.

In other words, the infrared confocal scanning microscope 200 of the present embodiment includes a wavelength selector, which selects the wavelength of light applied onto the sample in accordance with the sample 280, and this wavelength selector comprises the light source unit 210 and controller 256.

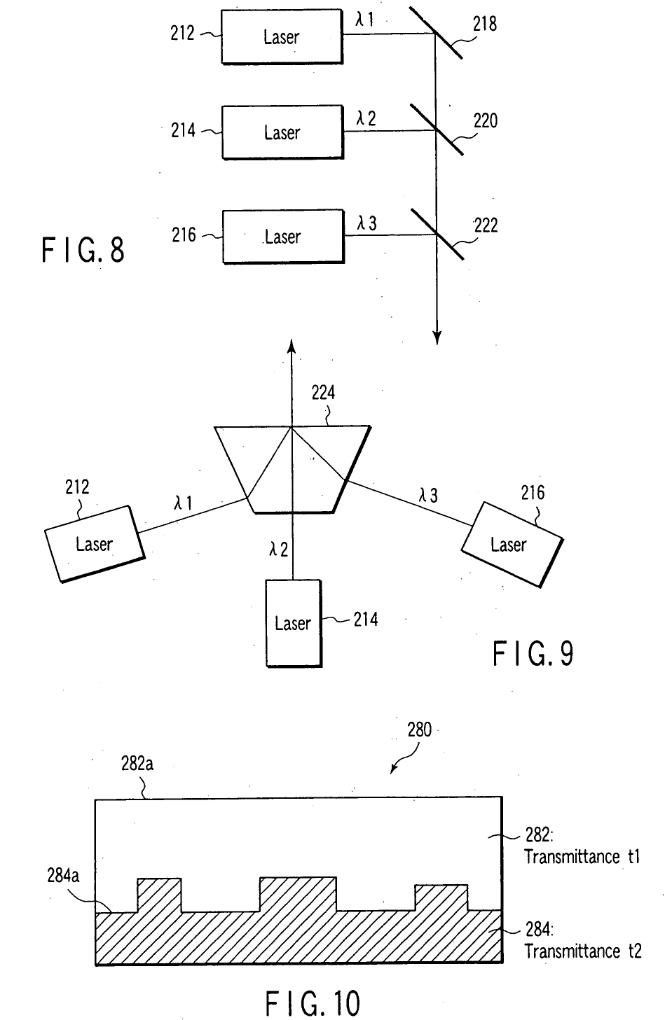

FIG. 8 shows a constitution of the light source unit 210 shown in FIG. 7. As shown in FIG. 8, the light source unit 210 includes three light sources 212 and 214 and 216. Three light sources 212 and 214 and 216 are but not limited to, for example, semiconductor laser. The light sources 212 and 214 and 216 may be also solid or gas laser.

Three semiconductor lasers 212, 214, and 216 respectively emit light having different wavelengths λ1, λ2, and λ3. For example, the semiconductor lasers 212, 214, and 216 respectively emit light having a wavelength λ1=980 nm, λ2=1300 nm, and λ3=1500 nm.

The light source unit 210 further includes a mirror 218, which deflects a beam of light from the semiconductor laser 212, a half mirror 220, which deflects a beam of light from the semiconductor laser 214, and a half mirror 222, which deflects a beam of light from the semiconductor laser 216. The mirror 218 and the half mirrors 220 and 222 deflect the beams of light from the corresponding semiconductor laser along the same optical axis (i.e., connect the beams of light to the same optical path).

The light source unit 210 selectively drives the semiconductor lasers 212, 214, and 216 to allow controlling on/off of the semiconductor lasers 212, 214, and 216, so as to select the wavelength of light to be emitted.

For example, when the material of the sample 280 is silicon, the wavelength is 1300 nm or more to obtain a transmittance of silicon of about 50%. Therefore, a switch of the semiconductor laser 214 with 1300 nm is turned on in consideration of image resolution, and switches of the other semiconductor lasers 212 and 216 are turned off.

Moreover, when the material of the sample 280 is unknown, each of the semiconductor lasers 212, 214, and 216 is driven in order from a low wavelength to actually acquire the image. It is assumed that the semiconductor laser that gives a clearest image among the images obtained in this manner is used as a light source. Alternatively, in changing of the semiconductor laser to be driven, the semiconductor laser is driven when a sufficiently clear image is obtained may be also used as a light source.

In the light source unit 210 shown in FIG. 8, the half mirrors 220 and 222, which respectively deflect the beams of light from the semiconductor lasers 214 and 216, may be semi-transparent optical devices such as a beam splitter. More preferably, a polarizing beam splitter, a dichroic mirror or the like may be used instead of the half mirror. In this case, the light from the light source may be applied to the sample with less loss. In the embodiment, the light source unit 210 includes three semiconductor lasers, but the number of lasers is not limited to that, and any number of semiconductor lasers can be employed.

FIG. 9 shows another constitution of the light source unit 210 shown in FIG. 7. In FIG. 9, members denoted with the same reference numerals as those of the members shown in FIG. 8 are similar members, and detailed description is omitted.

As shown in FIG. 9, the light source unit 210 has the semiconductor lasers 212, 214, and 216, and an optical prism 224, which connects the beams of light emitted from the respective semiconductor lasers to the same optical path. The optical prism 224 preferably has a high transmittance in an infrared wavelength, and a high refractive index. Dependence of the refractive index of an infrared wavelength region on wavelength is preferably little. At this time, the prism needs to be installed in consideration of the refractive index of the prism in each wavelength.

The wavelength is switched by selectively driving the semiconductor lasers 212, 214, and 216 to allow controlling on/off of the semiconductor lasers 212, 214, and 216.

For example, when the surface material of the sample 280 is silicon, the wavelength is 1300 nm or more to obtain a transmittance of silicon of about 50%. Therefore, the switch of the semiconductor laser 214 with 1300 nm is turned on in consideration of the image resolution, and the switches of the other semiconductor lasers 212 and 216 are turned off.

Moreover, when the material of the sample 280 is unknown, each of the semiconductor lasers 212, 214, and 216 is driven in order from a low wavelength to actually acquire the image. It is assumed that the semiconductor laser that gives the clearest image among the images obtained in this manner is used as a light source. Alternatively, in changing of the semiconductor laser to be driven, the semiconductor laser is driven when a sufficiently clear image is obtained may be also used as a light source.

In the light source unit 210 shown in FIG. 9, the number of semiconductor lasers is three, but the number of semiconductor lasers may be also increased with the optical prism 224 replaced with a prism having more surfaces.

In the present embodiment, for example, the Z-stage 246 is positioned with respect to the sample 280 shown in FIG. 10 so that the focal position falls on a sample inner surface 284a to obtain a confocal image. It is assumed that a transmittance of a surface material 282 of the sample 280 with respect to the light source wavelength λ at this time is t1, and a transmittance of an inner material 284 is t2. In this case, when a value of t1 is small, that is, when most light is reflected by a surface 282a of the surface material 282 of the sample, and there is little reflected light from the sample inner surface 284a, a transmission image becomes unclear. In this case, when the light source for use is changed (the wavelength is changed) to obtain a light source wavelength λ′ having a sufficiently large t1, it is possible to obtain a clear transmission three-dimensional microscope image. When the resolution is worse than a required resolution, attention is paid in such a manner that the transmittance t1 of the surface material is not excessively small, the light source for use is changed to a source emitting light having a short wavelength, and it is accordingly possible to obtain an image having a higher resolution. Accordingly, a clear transmission three-dimensional microscope image can be obtained.

In the infrared confocal scanning microscope 200 of the present embodiment, the light source unit 210 can emit the light having a wavelength suitable for the sample without replacing a light emitting device such as a laser. That is, it is possible to easily select the light having a wavelength suitable for the sample.

In the infrared confocal scanning microscope 200, the optical device (wave plate, mirror, PBS or the like) for use may be preferably changed in accordance with the switching of the wavelength of light for use in the light source unit 210. The changing of the optical device is performed, for example, by replacing the optical device disposed on the optical path. Alternatively, the changing is performed by switching the optical path to cause the light to pass through the corresponding optical device.

Moreover, in the infrared confocal scanning microscope 200, for example, the output of the light source unit 210 may be preferably adjusted in accordance with the switching of the wavelength of the light emitted from the light source unit 210 so that brightness of the obtained image becomes equal regardless of the switched wavelength of the light.

When the wavelength of the light emitted from the light source unit 210 changes, the light intensity detected by the photodetector 254 changes for an output difference of the semiconductor laser or wavelength characteristics of the photodetector. As a result, the brightness of the obtained image fluctuates. That is, the fluctuation of brightness of the image is caused in accordance with the wavelength selected in the light source unit 210.

It is possible to cancel the brightness change of the image by adjustment of the output of the light source for use, that is, the semiconductor laser. The output of the light source is preferably automatically adjusted through a computer or an electric circuit.

A method of correcting the fluctuation of the brightness of the image is not limited to the adjustment of the output of the light source. For example, the correction may be also performed by adjustment of sensitivity of the photodetector 254. The correction may be also performed by inserting an ND filter having an appropriate transmittance or the like onto the optical path. Alternatively, the photodetector for use may be also replaced in accordance with the light source for use. In this case, a plurality of photodetectors are switchably disposed in accordance with the wavelengths of the semiconductor lasers, and the corresponding photodetector may be also disposed in an appropriate position in accordance with the switching of the semiconductor laser for use.

In the present embodiment, when the sample material is unknown, the light source is selected based on clearness of the image, but the light source uses the semiconductor laser that emits light having a short wavelength in a range having a not-excessively low detection strength in the photodetector 254 while the sample inner surface 284a is focused at maximum wavelength and the semiconductor laser is then successively switched.

Moreover, the semiconductor laser is preferably controlled to be on/off for the wavelength selection automatically by the controller 256. As a method of selecting the wavelength, shutters or the like for interrupting the light are disposed before the semiconductor lasers 212, 214, and 216, and the respective shutters may be opened/closed in accordance with the wavelength for use to select the wavelength.

Modification

For example, to scan the light spot in the plane perpendicular to the optical axis of the surface or the inside of the sample 280, instead of the two-dimensional scanning mechanism 230, an XY stage for moving the sample 280 in the plane vertical to the optical axis may be also used. Instead of the two-dimensional scanning mechanism 230, a one-dimensional scanning mechanism, which one-dimensionally scans the beam of infrared light, may be combined with a stage for moving the sample 280 in the plane vertical to the optical axis in a direction perpendicular to the scanning direction.

Moreover, relative movement along the optical axis of the light spot and sample 280 may be also performed by an objective lens movement mechanism for moving the objective lens 242 along the optical axis instead of the Z-stage 246, which moves the sample 280 along the optical axis.

Furthermore, the optical device for connecting the light beams emitted from light sources to the same optical path may comprise an acoustic optical device. A wavelength selector, which selects the wavelength of light emitted from the light source unit 210, may be constituted using a variable wavelength laser using optical devices such as grating, instead of selectively driving the semiconductor lasers. In this case, it is possible to finely change the wavelength of the light for use in a broad range.

Additionally, in the above-described embodiment, an example has been described in which the sample is observed with light having a single wavelength, but the sample may be also observed with light having a plurality of wavelengths. Therefore, a constitution may include a plurality of photodetectors suitable for light sources, and an optical system that splits and guides the beam of light that has passed through the pinhole into the corresponding photodetector. Accordingly, a plurality of light sources are simultaneously driven to simultaneously apply a plurality of beams of light having different wavelengths to a multilayered sample, a plurality of reflected beams of light reflected by the respective layers are split by a filter or the like after passage through a micro opening, and detected by the respective photodetectors, and it is accordingly possible to observe the inside of the multilayered sample by one scan.

Third Embodiment

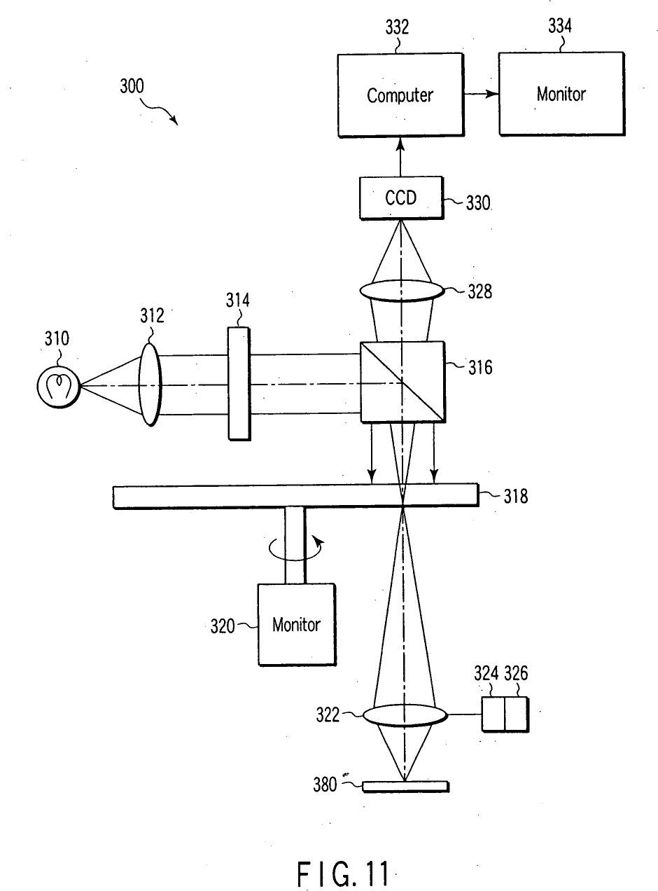

The present embodiment is directed to an infrared confocal scanning microscope of disc scanning type. FIG. 11 shows a constitution of the infrared confocal scanning microscope according to a third embodiment of the present invention.

As shown in FIG. 11, an infrared confocal scanning microscope 300 has a light source 310, which emits a beam of light including infrared light, a collimator lens 312, which sets the beam of light from the light source 310 to be parallel, an infrared wavelength filter 314, which transmits the infrared light, a half mirror 316, which deflects the beam of infrared light from the infrared wavelength filter 314, a rotary disc 318, which cuts across the beam of infrared light deflected by the half mirror 316, and a motor 320, which rotates the rotary disc 318. The rotary disc 318 has a plurality of pinholes, which function as micro openings.

The infrared confocal scanning microscope 300 further includes an objective lens 322, which converges the beam of infrared light that has passed through the pinhole of the rotary disc 318 to form a light spot inside a sample 380, an objective lens movement mechanism 324, which moves the objective lens 322 along the optical axis, and a Z-scale 326, which detects the movement along the optical axis of the objective lens 322.

The infrared confocal scanning microscope 300 further includes a converging lens 328, which converges the beam of reflected infrared light from the sample 380 via the objective lens 322, rotary disc 318, and half mirror 316, a CCD camera 330 as an image pickup device, which can detect the reflected infrared light from the converging lens 328 in a region having a two-dimensional spread, a computer 332 as a controller, which performs processing of information obtained by the CCD camera 330, and a monitor 334, which displays a processing result (image) obtained by the computer 332.

The light source 310 is a light source, which emits the light including the infrared light, and is, but not limited to, for example, a halogen lamp having large luminance in an infrared region. The beam of light emitted from the light source 310 is set to be parallel by the collimator lens 312, and enters the infrared wavelength filter 314, and only the infrared light having a desired wavelength band passes through the filter. The infrared light that has passed is reflected by the half mirror 316, and applied to the rotary disc 318. The rotary disc 318 is referred to, for example, as a Nipkow disk, in which a plurality of pinholes are spirally formed, or a disc in which a slit-shaped pattern is formed. The Nipkow disk will be described hereinafter.

This rotary disc 318 is attached to a rotation shaft of the motor 320, and is rotated at a predetermined rotation speed. The light applied to the rotary disc 318 passes through a plurality of pinholes formed in the rotary disc 318, and is converged on the surface or the inside of the sample 380 by the objective lens 322 to form the light spot. The objective lens 322 is, for example, an infinity objective lens in which aberration of light having a use wavelength of 1.3 μm in a visible range to an infrared range is corrected.

The reflected light from the sample 380 passes through the objective lens 322 and the pinholes of the rotary disc 318 again, passes through the half mirror 316, and falls on the CCD camera 330 by the converging lens 328. The CCD camera 330 has a sensitivity in an infrared wavelength region, picks up an image of the reflected light from the sample 380, and outputs the image signal.

The computer 332 takes in the image signal output from the CCD camera 330, processes the image to store desired image data, and displays the image in the monitor 334.

In the infrared confocal scanning microscope 300, the light spot formed on the surface or the inside of the sample 380 is moved (i.e., scanned) with the movement of the pinhole with the rotation of the rotary disc 318. The CCD camera 330 is capable of detecting the light in a region having a two-dimensional spread. The reflected light from the light spot formed on the surface or the inside of the sample 380 falls on a point (micro region or pixel) on the light receiving region of the CCD camera 330 disposed in the confocal position with respect to the light spot via the pinhole. As a result, an image on the plane perpendicular to the optical axis on which the light spot is positioned is output from the CCD camera 330.

As described in the first embodiment, in the optical confocal system, only the reflected light from the focal position has a high intensity, and the intensity rapidly decreases off the focus. Therefore, there is little noise light, and a clear image is obtained at a focus time. Accordingly, it is possible to clearly observe the inside of a semiconductor crystal or a bonded portion of IC after mounting the substrate.

In the present embodiment, a constitution in which the image is acquired using the computer has been described, but the image may only be displayed in a television monitor. In the same manner as in the conventional constitution of the infrared microscope, the constitution may also comprise a visual observation optical path and an infrared observation optical path for performing infrared observation by a television camera. Additionally, needless to say, in this case, the infrared wavelength filter 314 for transmitting only the infrared light is unnecessary. The rotary disc is not limited to the above-described disc, and any other constitution may be also used as long as a confocal effect is obtained.

Modification

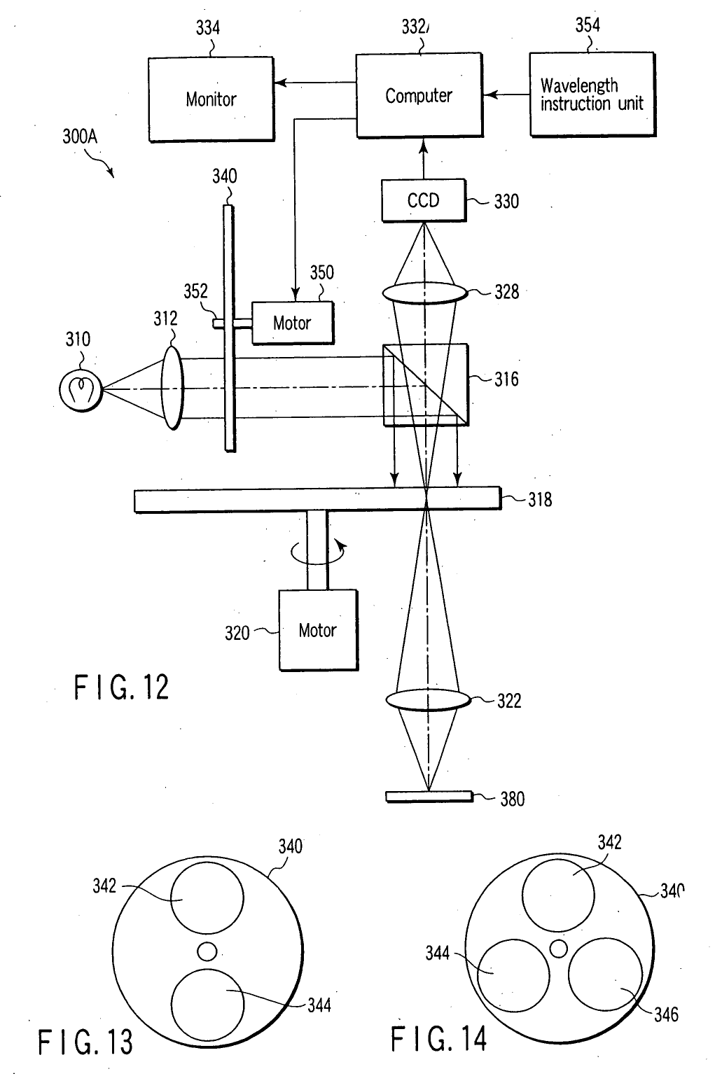

FIG. 12 shows a constitution of a modification of the infrared confocal scanning microscope of disc scanning type according to the present embodiment. In FIG. 12, members denoted with the same reference numerals as those of the members shown in FIG. 11 are similar members, and detailed description is omitted.

Instead of the infrared wavelength filter 314 in the constitution of the infrared confocal scanning microscope 300, an infrared confocal scanning microscope 300A of the present modification has an infrared wavelength filter turret 340, which crosses the beam of infrared light from the collimator lens 312, and a motor 350, which rotates the infrared wavelength filter turret 340. The infrared wavelength filter turret 340 is attached to a rotation shaft 352 of the motor 350, and is rotatably supported.

The infrared wavelength filter turret 340 includes a plurality of filters in order to select the wavelength of the light to be applied to the sample 380 as described later with reference to FIGS. 13 or 14. One of the filters is selectively disposed on the optical path.

The infrared confocal scanning microscope 300A further includes a wavelength instruction unit 354 for indicating a wavelength to be selected. Accordingly, a computer 332A as a controller in place of the computer 332 has a function of controlling the motor 350 in accordance with the indication from the wavelength instruction unit 354 in addition to the function of the computer 332.

In other words, the infrared confocal scanning microscope 300A of the present modification has a wavelength selector, which selects the wavelength of light to be applied to the sample in accordance with the sample 380, and this wavelength selector comprises the infrared wavelength filter turret 340, motor 350, wavelength instruction unit 354, and computer 332A.

In the infrared confocal scanning microscope 300A of the present modification, the beam of light emitted from the light source 310 is set to be parallel by the collimator lens 312, and enters the infrared wavelength filter turret 340. The infrared wavelength filter turret 340 includes a plurality of filters, which respectively transmit the infrared light in a specific wavelength band, and one of the filters is disposed on the optical path. The infrared light that has passed through the filter of the infrared wavelength filter turret 340 is reflected by the half mirror 316, and applied to the sample 380 via the pinholes of the rotary disc 318.

The reflected light from the sample 380 falls on the CCD camera 330 via the objective lens 322, rotary disc 318, half mirror 316, and converging lens 328. As described above, the image on the plane that is perpendicular to the optical axis and on which the light spot formed on the surface or the inside of the sample 380 is positioned is observed.

The computer 332A controls the motor 350 in accordance with the indication from the wavelength instruction unit 354, so that the filters of the infrared wavelength filter turret 340 are rotated to dispose a desired filter on the optical path. The wavelength instruction unit 354 may be realized by hardware for exclusive use or by software, which operates on the computer 332A.

In the infrared confocal scanning microscope 300A of the present modification, for example, as shown in FIG. 13, the infrared wavelength filter turret 340 includes two filters 342 and 344, which respectively have different transmit wavelength bands, and one of the filters is selectively disposed on the optical path. For example, the filter 342 comprises a band pass filter centering on 1200 μm, and the filter 344 comprises a band pass filter centering on 1300 μm. It is possible to more clearly observe the inside of a semiconductor crystal or a bonded portion of IC after mounting the substrate by preparing band pass filters and selecting an observation wavelength band suitable for the observation sample by the filters.

It is to be noted that in the present embodiment, the number of selectable wavelength bands is set to two. However, in a constitution in which more wavelength bands can be selected, it is possible to select the observation wavelength band more suitable for the observation sample.

Moreover, for example, as shown in FIG. 14, the infrared wavelength filter turret 340 may include a filter 346, which transmits visible light, in addition to two filters 342 and 344, which transmit the infrared light. According to the infrared wavelength filter turret 340, the inside of the semiconductor crystal, the bonded portion of the IC on which the substrate has been mounted, and the like can be observed by locating one of two filters 342 and 344 transmitting the infrared light on the optical path. Additionally, it is possible to perform usual confocal observation by locating the filter 346 transmitting the visible light on the optical path.

Moreover, the rotary disc is not limited to the above-described disc, and any other constitution may be also used as long as the confocal effect is obtained.

Another Modification

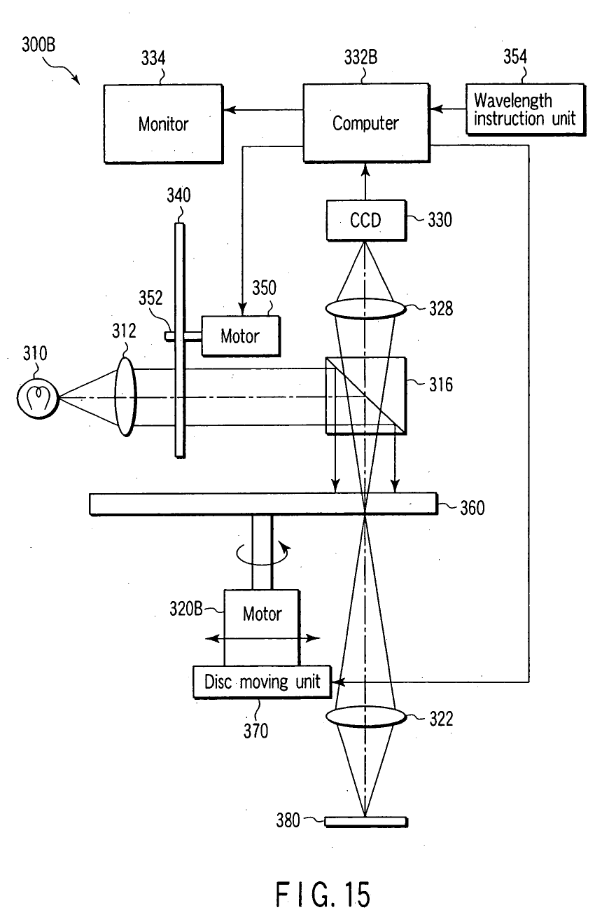

FIG. 15 shows a constitution of another modification of the infrared confocal scanning microscope of disc scanning type according to the present embodiment. In FIG. 15, the members denoted with the same reference numerals as those of the members shown in FIG. 12 are similar members, and the detailed description is omitted.

An infrared confocal scanning microscope 300B of the present modification has another rotary disc 360 instead of the rotary disc 318 in the constitution of the infrared confocal scanning microscope 300A. Accordingly, the microscope has a motor 320B for rotating the rotary disc 360 is disposed instead of the motor 320 for rotating the rotary disc 318, and a disc moving unit 370, which moves the rotary disc 360 together with the motor 320B in a direction perpendicular to the optical axis.

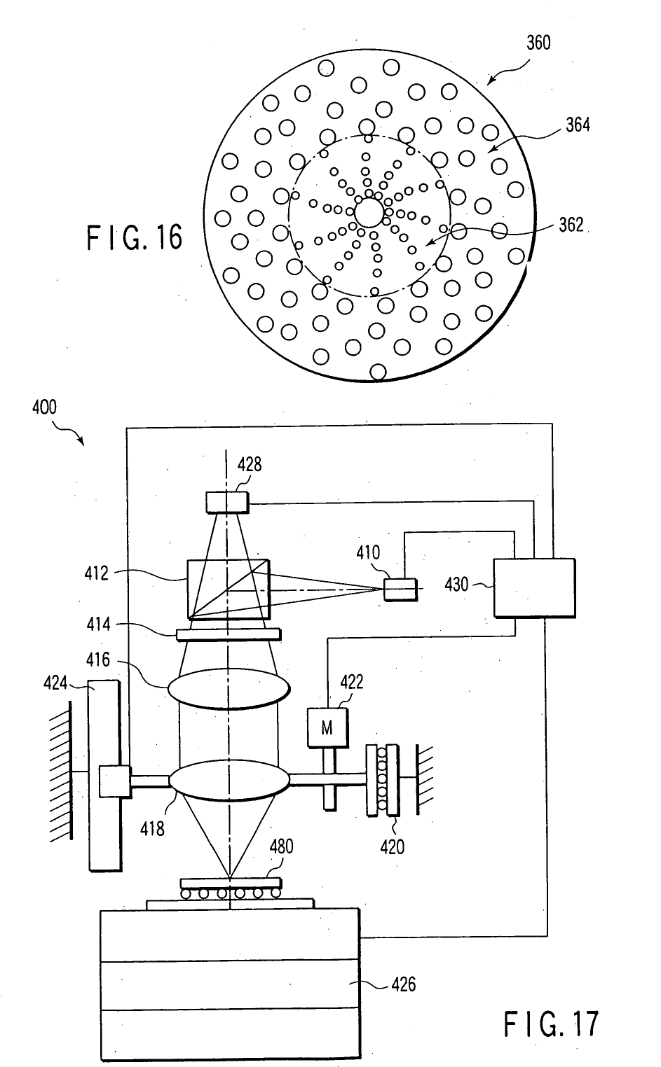

As shown in FIG. 16, the rotary disc 360 has a plurality of regions having different arrangement patterns of pinholes, such as regions 362 and 364. The region 362 is different from the region 364 in the arrangement pattern of pinholes, and the diameter or pitch of the pinhole.

In the infrared confocal scanning microscope 300B of the present modification, in FIG. 15, the beam of light emitted from the light source 310 is set to be parallel by the collimator lens 312, and enters the infrared wavelength filter turret 340. The infrared wavelength filter turret 340 includes a plurality of filters, which respectively transmit the infrared light in a specific wavelength band, and one of the filters is disposed on the optical path. The infrared light that has passed through the filter of the infrared wavelength filter turret 340 is reflected by the half mirror 316, and is applied to the sample 380 via the pinholes of the rotary disc 318.

The reflected light from the sample 380 falls on the CCD camera 330 via the objective lens 322, rotary disc 318, half mirror 316, and converging lens 328. As described above, the image on the plane perpendicular to the optical axis on which the light spot formed on the surface or the inside of the sample 380 is positioned is observed.

The filters of the infrared wavelength filter turret 340 are rotated to dispose a desired filter on the optical path, when the computer 332B controls the motor 350 in accordance with the indication from the wavelength instruction unit 354.

In the infrared confocal scanning microscope of disc scanning type, an optimum arrangement pattern of pinholes differs depending on the wavelength of light for use. In the rotary disc 360, with respect to the light for use, the region of more preferable arrangement pattern of pinholes, and either of the regions 362 and 364 are disposed on the optical path. It is to be noted that the region of the arrangement pattern of the pinholes is switched, when the disc moving unit 370 moves the rotary disc 360 together with the motor 320B in a direction perpendicular to the optical axis.

In the infrared confocal scanning microscope 300B of the present modification, in addition to the selection of the wavelength by the infrared wavelength filter turret 340, the arrangement pattern of the pinholes of the rotary disc 360 is changed to a more preferable pattern, and accordingly further preferable observation is possible in accordance with the sample.

That is, the arrangement pattern of the pinholes of the rotary disc 360 is switched in accordance with the filter for use in the infrared wavelength filter turret 340 to obtain an optimum confocal effect. Accordingly, the microscope is applicable to more samples, and it is possible to more clearly observe the inside of the semiconductor crystal, and the bonded portion of the IC on which the substrate has been mounted, and the like.

In the present embodiment, there are two filters for selecting the infrared light in the infrared wavelength filter turret 340, and two regions of the arrangement patterns of the pinholes of the rotary disc 360. However, the number of the component is not limited to this, and the infrared wavelength filter turret 340 may include more filters, and the rotary disc 360 may also include different regions of the arrangement patterns of the pinholes. Accordingly, it is possible to observe more samples on optimum conditions (wavelength and pinhole pattern). One-to-one correspondence does not have to be necessarily established between the filter for the selecting the infrared light in the infrared wavelength filter turret 340 and the region of the arrangement pattern of the pinholes of the rotary disc 360. If necessary, the infrared light of a plurality of wavelength bands may be also handled by the arrangement pattern of one of the pinholes of the rotary disc 360.

Moreover, the rotary disc is not limited to the above-described disc, and any other system may be also used in the constitution in which the confocal effect is obtained.

Fourth Embodiment

The present embodiment is directed to a height measurement apparatus using infrared light. FIG. 17 shows a constitution of the height measurement apparatus according to a fourth embodiment of the present invention.

As shown in FIG. 17, a height measurement apparatus 400 of the present embodiment has a stage 426 capable of moving a mounted sample 480 in a plane perpendicular to the optical axis, a light source unit 410, which emits a beam of infrared light passing through silicon, a polarizing beam splitter 412, which deflects the beam of infrared light from the light source unit 410, an objective lens 418, which converges the beam of infrared light to form a light spot inside the sample 480, a support mechanism 420, which movably supports the objective lens 418 along an optical axis, an objective lens movement mechanism (motor) 422, which moves the objective lens 418 along the optical axis, and a linear scale 424, which detects the movement of the objective lens 418 along the optical axis.

The height measurement apparatus 400 further includes a quarter-wave plate 414 and an image forming lens 416, and these components are positioned between the polarizing beam splitter 412 and the objective lens 418. The quarter-wave plate 414 cooperates with the polarizing beam splitter 412 to separate the infrared light directed to the sample 480 from the light source unit 410 from the infrared light reflected by the sample 480. The reflected infrared light from the separated sample 480 passes through the polarizing beam splitter 412. The image forming lens 416 forms the reflected infrared light from the sample 480 into the image.

The height measurement apparatus 400 further includes a photodetector 428, which detects the focusing of the reflected infrared light from the sample 480, and a controller, that is, a calculation processing device 430, which controls the light source unit 410, objective lens movement mechanism, and stage 426, and processes the information from the linear scale 424 and photodetector 428.

In FIG. 17, the beam of infrared light emitted from the light source unit 410 is reflected by the polarizing beam splitter 412, passes through the quarter-wave plate 414, and enters the image forming lens 416. The beam of infrared light that has entered the image forming lens 416 is changed to a parallel beam by the image forming lens 416, and converged by the objective lens 418 to form the light spot on the surface or the inside of the sample 480.

The infrared light reflected by the surface or the inside of the sample 480 passes through the objective lens 418, image forming lens 416, and quarter-wave plate 414, subsequently passes through the polarizing beam splitter 412, and falls on the photodetector 428. The photodetector 428 outputs information indicating a shift amount with respect to the focal position of the objective lens 418 to the calculation processing device 430. The calculation processing device 430 controls the motor 422 and adjusts the focal position of the objective lens 418 based on luminance information from the photodetector 428 (a focal point detection method by a climbing method, in which a peak position of an I-Z signal is detected as a focal position) so that luminance information is maximized.

That is, the height measurement apparatus 400 has an auto focusing mechanism using the infrared light that passes through silicon.

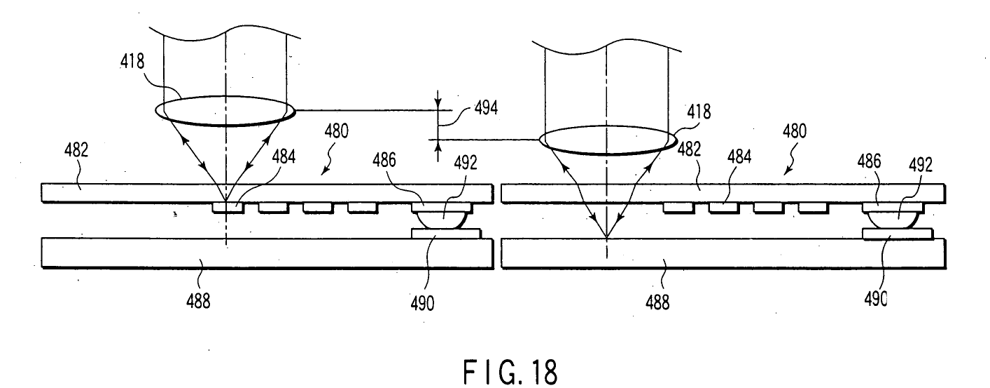

The height measurement apparatus 400 of the present embodiment is capable of measuring a relative height among a plurality of object surfaces. An example of gap measurement of an FCB mounted package will be described hereinafter with respect to height measurement by the height measurement apparatus 400. FIG. 18 is an optical path diagram of the gap measurement of the FCB mounted package.

As shown in FIG. 18, the package 480 as a measurement object includes, for example, a silicon chip 482 bonded to a printed substrate 488 by a bump 492. For example, the silicon chip 482 includes a wiring pattern 484 and an aluminum pad 486, the printed substrate 488 includes a land 490, and the aluminum pad 486 is electrically connected to the land 490 by the bump 492.

Here, a gap between the lower surface of the silicon chip 482 and the upper surface of the printed substrate 488 is measured.

First, the package 480 is moved by the stage 426 to position the package 480 in such a manner that the wiring pattern 484 formed on the lower surface of the silicon chip 482 is positioned on the optical axis as shown on the left side of FIG. 18. The objective lens 418 is moved along the optical axis based on the luminance information obtained by the photodetector 428 by the calculation processing device 430, and a converging point of the beam of infrared light is adjusted to the lower surface of the silicon chip 482, that is, the upper surface of the wiring pattern 484. A read value of the linear scale 424 at this time is set to a reference value.

Next, as shown on the right side of FIG. 18, by the stage 426, the sample 480 is moved in the X-Y plane to a position where the wiring pattern 484 formed on the lower surface of the silicon chip 482 deviates from the beam of infrared light. The position is preferably close to the prior measurement position. The calculation processing device 430 moves the objective lens 418 along the optical axis based on the luminance information obtained by the photodetector 428 to adjust the lens to the upper surface of the printed substrate 488.

A movement amount 494 of the objective lens 418 at this time is equal to a gap between the lower surface of the silicon chip 482 and the upper surface of the printed substrate 488, and this is measured as a movement amount with respect to the above-described reference value of the linear scale 424 in the calculation processing device 430.

In this manner, the height measurement apparatus 400 of the present embodiment is capable of measuring the relative height among a plurality of object surfaces inside the samples 480 such as the FCB mounted package.

Furthermore, similar measurement is performed in a multiplicity of points, a large number of pieces of obtained height information are processed, and it is also possible to obtain, for example, an average of gaps among the plurality of object surfaces or parallel degrees of the object surfaces.

Additionally, the height measurement apparatus 400 may be mounted on a mounting apparatus, and measurement may be also performed on the mounting apparatus. In this manner, the relative height of the object surface inside the samples such as silicon or FCB mounted package, which does not transmit the visible light, can be directly measured, and therefore the measuring of the height of the bonded portion and the setting of pressurizing conditions can be performed with good precision.

Modification

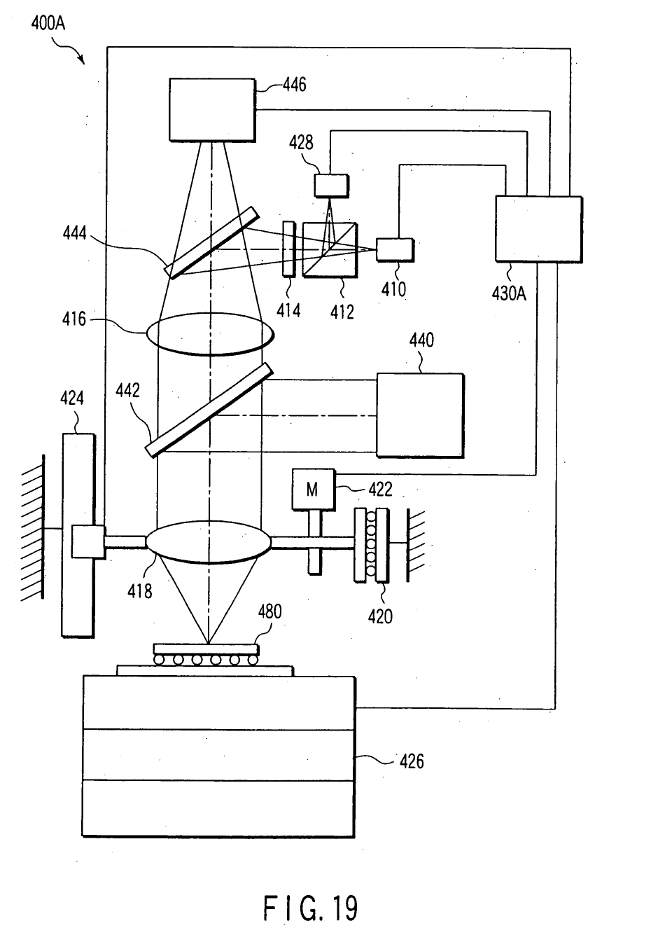

FIG. 19 shows a constitution of a modification of the height measurement apparatus according to the present embodiment. In FIG. 19, the members denoted with the same reference numerals as those of the members shown in FIG. 17 are similar members, and the detailed description is omitted.

In addition to the constitution of the height measurement apparatus 400, a height measurement apparatus 400A of the present modification has an infrared light source 440, which emits infrared illuminative light, a beam splitter 442, which reflects the infrared illuminative light from the infrared light source 440 toward the objective lens 418 and passes the infrared illuminative light reflected by the sample 480, a beam splitter 444, which separates the infrared illuminative light reflected by the sample 480 from the infrared light emitted from the light source unit 410, and an infrared image pickup device 446, which receives the infrared illuminative light that has passed through the beam splitter 444.

Accordingly, a calculation processing device 430A in place of the calculation processing device 430 controls the light source unit 410, motor 422, and stage 426, and processes the information from the linear scale 424 and photodetector 428. Additionally, the device is capable of processing even the information from the infrared image pickup device 446, that is, the image.

The beam splitter 442 preferably only transmits the infrared light emitted from the light source unit 410.

In the height measurement apparatus 400A of the present modification, the height measurement is performed completely in the same manner as in the height measurement apparatus 400 except that the beam of infrared light emitted from the light source unit 410 passes through the beam splitters 444 and 442.

In the height measurement apparatus 400A of the present modification, the infrared illuminative light emitted from the infrared light source 440 is reflected by the beam splitter 442, and applied to the sample 480 via the objective lens 418. The infrared illuminative light reflected by the sample 480 passes through the objective lens 418, beam splitter 442, image forming lens 416, and beam splitter 444, and falls on the infrared image pickup device 446. The infrared image pickup device 446 obtains the image of the portion in the sample 480 that has reflected the infrared illuminative light.

In the height measurement apparatus 400A, it is possible to confirm the positions of the portions that reflect the infrared light inside the sample 480, such as the bump 492, wiring pattern 484, and the like in the package 480 shown, for example, in FIG. 18 based on the image obtained by the infrared image pickup device 446. It is accordingly possible to perform the positioning during the height measurement in a short time.

In the present modification, the infrared illuminative light is applied onto the sample 480 via the objective lens 418 by reflected illumination that is coaxial with the optical system for the height measurement. However, the sample 480 may be also illuminated by oblique illumination, in which light is obliquely applied from the outside of the objective lens 418.

The embodiments of the present invention have been described above with reference to the drawings, but the present invention is not limited to these embodiments, and various modifications or changes may be also applied in a range that does not depart from the scope.

Moreover, an object sample in which silicon is used has been mainly described in the first to fourth embodiments, but this is not limited as long as the sample passes the infrared light.

Moreover, it is possible to appropriately combine the constitutions described in the first to fourth embodiments. For example, it is also possible to dispose the wavelength selector described in the second embodiment in the device of the first embodiment so that the wavelength for use can be selected. Alternatively, the device of the first or second embodiment may be also provided with the auto focusing function of the fourth embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An infrared confocal scanning microscope for observation of the inside of a sample, comprising:
a light source unit, which emits a beam of infrared light;
an objective lens, which converges the beam of infrared light from the light source unit to form a light spot inside the sample;
a scanning mechanism, which two-dimensionally scans the light spot in a plane perpendicular to an optical axis; and
a photodetector including a micro light receiving region, which is in a confocal positional relation with respect to the light spot, and constitutes a substantial micro opening.

2. The infrared confocal scanning microscope according to claim 1, further comprising: a moving mechanism, which relatively moves the objective lens and the sample along the optical axis; a movement detector, which detects the relative movement between the objective lens and the sample along the optical axis; and a controller, which measures relative positions of a plurality of portions in the sample along the optical axis based on the detected movement.

3. The infrared confocal scanning microscope according to claim 2, wherein the controller forms an image of a plane in which the light spot is positioned based on the information obtained by the photodetector and positional information of the light spot, and measures the relative positions of the plurality of portions in the sample positioned in the same plane perpendicular to the optical axis based on the obtained image.

4. The infrared confocal scanning microscope according to claim 3, wherein the controller synthesizes a plurality of images in a plurality of positions along the optical axis to form an image (extended image) focused in all of the plurality of positions along the optical axis.

5. The infrared confocal scanning microscope according to claim 4, wherein the controller measures relative positions of a plurality of portions in the sample positioned in different planes perpendicular to the optical axis in different positions along the optical axis based on the formed extended image.

6. The infrared confocal scanning microscope according to claim 2, further comprising: a wavelength selector, which selects a wavelength of light to be applied to the sample in accordance with the sample, wherein the controller corrects fluctuation of brightness of the image caused in accordance with the selected wavelength.

7. The infrared confocal scanning microscope according to claim 1, wherein aberration caused by the sample is corrected in the objective lens.

8. The infrared confocal scanning microscope according to claim 1, wherein the objective lens has a function of correcting aberration caused by the sample.

9. The infrared confocal scanning microscope according to claim 8, wherein the objective lens has a rotatable correction ring, and an optical element moved along the optical axis with rotation of the correction ring.

10. The infrared confocal scanning microscope according to claim 1, further comprising: a wavelength selector, which selects a wavelength of light to be applied to the sample in accordance with the sample.

11. The infrared confocal scanning microscope according to claim 10, wherein the light source unit includes a plurality of light sources, the plurality of light sources respectively emit light having different wavelengths, and the wavelength selector selectively drives the plurality of light sources to select the wavelength of the light to be applied to the sample.

12. The infrared confocal scanning microscope according to claim 10, wherein the light source unit emits light having a plurality of wavelengths, the wavelength selector includes a plurality of filters, which respectively transmit the light of different wavelength bands, and one of the filters is selectively disposed in an optical path to select the wavelength of the light to be applied to the sample.

13. The infrared confocal scanning microscope according to claim 10, wherein the light source unit includes a plurality of light sources, the plurality of light sources respectively emit light having different wavelengths, and the wavelength selector controls shutters respectively disposed before the plurality of light sources to interrupt the light, so that the wavelength of the light to be applied to the sample is selected.

14. An infrared confocal scanning microscope for observation of the inside of a sample, comprising:
a light source unit, which emits a beam of infrared light;
an objective lens, which converges the beam of infrared light from the light source unit to form a light spot inside the sample;
a scanning mechanism, which two-dimensionally scans the light spot in a plane perpendicular to an optical axis;
a substantial micro opening, which is in a confocal positional relation with respect to the light spot; and
a photodetector to detect reflected (infrared) light that has passed through the micro opening from the sample.

15. The infrared confocal scanning microscope according to claim 14, further comprising: a moving mechanism, which relatively moves the objective lens and the sample along the optical axis; a movement detector, which detects the relative movement between the objective lens and the sample along the optical axis; and a controller, which measures relative positions of a plurality of portions in the sample along the optical axis based on the detected movement.

16. The infrared confocal scanning microscope according to claim 15, wherein the controller forms an image of a plane in which the light spot is positioned based on the information obtained by the photodetector and positional information of the light spot, and measures the relative positions of the plurality of portions in the sample positioned in the same plane perpendicular to the optical axis based on the obtained image.

17. The infrared confocal scanning microscope according to claim 16, wherein the controller synthesizes a plurality of images in a plurality of positions along the optical axis to form an image (extended image) focused in all of the plurality of positions along the optical axis.

18. The infrared confocal scanning microscope according to claim 17, wherein the controller measures relative positions of a plurality of portions in the sample positioned in different planes perpendicular to the optical axis in different positions along the optical axis based on the formed extended image.

19. The infrared confocal scanning microscope according to claim 14, wherein aberration caused by the sample is corrected in the objective lens.

20. The infrared confocal scanning microscope according to claim 14, wherein the objective lens has a function of correcting aberration caused by the sample.

21. The infrared confocal scanning microscope according to claim 14, further comprising: a wavelength selector, which selects a wavelength of light to be applied to the sample in accordance with the sample.

22. An infrared confocal scanning microscope for observation of the inside of a sample, comprising:
a light source unit, which emits a beam of infrared light;
an objective lens, which converges the beam of infrared light from the light source unit to form a light spot inside the sample;
a scanning mechanism, which two-dimensionally scans the light spot in a plane perpendicular to an optical axis;
a disc, which is in a confocal positional relation with respect to the light spot and on which light transmitting portions and light interrupting portions are formed with predetermined patterns crossing an optical path of the infrared light; and
an image pickup device capable of detecting the light in a region that has a two-dimensional spread.

23. The infrared confocal scanning microscope according to claim 22, further comprising: a moving mechanism, which relatively moves the objective lens and the sample along the optical axis; a movement detector, which detects the relative movement between the objective lens and the sample along the optical axis; and a controller, which measures relative positions of a plurality of portions in the sample along the optical axis based on the detected movement.

24. The infrared confocal scanning microscope according to claim 23, wherein the controller forms an image of a plane in which the light spot is positioned based on the information obtained by the photodetector and positional information of the light spot, and measures the relative positions of the plurality of portions in the sample positioned in the same plane perpendicular to the optical axis based on the obtained image.

25. The infrared confocal scanning microscope according to claim 24, wherein the controller synthesizes a plurality of images in a plurality of positions along the optical axis to form an image (extended image) focused in all of the plurality of positions along the optical axis.

26. The infrared confocal scanning microscope according to claim 25, wherein the controller measures relative positions of a plurality of portions in the sample positioned in different planes perpendicular to the optical axis in different positions along the optical axis based on the formed extended image.

27. The infrared confocal scanning microscope according to claim 23, further comprising: a wavelength selector, which selects a wavelength of light to be applied to the sample in accordance with the sample, wherein the controller corrects fluctuation of brightness of the image caused in accordance with the selected wavelength.

28. The infrared confocal scanning microscope according to claim 22, further comprising: a wavelength selector, which selects a wavelength of light to be applied to the sample in accordance with the sample.

29. The infrared confocal scanning microscope according to claim 28, wherein the light source unit emits light having a plurality of wavelengths, the wavelength selector includes a plurality of filters, which respectively transmit the light of different wavelength bands, and one of the filters is selectively disposed in an optical path to select the wavelength of the light to be applied to the sample.

30. A measuring method in which relative positions of a plurality of portions in a sample are measured, comprising:
converging a beam of infrared light to form a light spot inside the sample;
two-dimensionally scanning the light spot in a plane;
detecting reflected (infrared) light from the sample in a confocal position with respect to the light spot;
forming an image of the plane in which the light spot is positioned based on positions of the detected reflected (infrared) light and the light spot;
repeating these operations with changing a height position of the light spot to acquire a plurality of images;
synthesizing the plurality of acquired images to form an image (extended image) focused in all height positions; and
measuring relative positions of a plurality of portions in the sample based on the formed extended image.
